(19) United States
(12) Patent Application Publication
(10) Pub. No.: US 2012/0030372 A1
(43) Pub. Date: Feb. 2, 2012

(54) REDUNDANT ETHERNET CONNECTION SYSTEM AND METHOD

(75) Inventors: Paul Oliver Caffrey, Roanoke, VA (US); Mark Asfaw, Roanoke, VA (US); Abhishek Bhatt, Hyderabad (IN); Kumardeep Mazumder, Hyderabad (IN)

(73) Assignee: GENERAL ELECTRIC COMPANY, Schenectady, NY (US)

(21) Appl. No.: 12/847,533

(22) Filed: Jul. 30, 2010

(51) Int. Cl. G06F 15/173

(52) U.S. Cl. 709/238

(57) ABSTRACT

A system includes a first communication network including a first switch and a second switch connected to the first switch, a second communication network including a third switch and fourth switch coupled to the third switch, and a first computing device coupled to the first communications network through a first network interface controller (NIC) and coupled to the second communication network through a second NIC. The first computing device is configured to communicate through the first NIC first communication network until it determines that it is not receiving bridge protocol data units (BPDUs) and then to communicate through the second NIC.

### BACKGROUND OF THE INVENTION

The subject matter disclosed herein relates to communications and, in particular, to providing redundant Ethernet connections.

Control systems typically include multiple nodes. These nodes are typically in communication with one another, either directly or indirectly. One communication approach is to couple the node together through an Ethernet.

Ethernet is a family of frame-based computer networking technologies for local area networks (LANs). The name came from the physical concept of the ether. The Ethernet protocol defines a number of wiring and signaling standards for the Physical Layer of the OSI networking model as well as a common addressing format and Media Access Control at the Data Link Layer.

In today's environment there is much concern for redundancy to keep facilities that employ control systems up and running. This is an area of prime importance as the cost of downtime and lost production can often times make the difference between profit and loss. Communications connection redundancy is one area of prime importance because communication is the backbone of any effective control system. Accordingly, some or all devices in a control system may be coupled together by two different Ethernets. Stated differently, each device may be coupled to two different Ethernet switches, each of which is connected to a different Ethernet.

### BRIEF DESCRIPTION OF THE INVENTION

According to one aspect of the invention, a system including redundant communication paths is disclosed. The system includes a first communication network including a first switch and a second switch connected to the first switch and a second communication network including a third switch and fourth switch coupled to the third switch. The system also includes a first computing device coupled to the first communications network through a first network interface controller (NIC) and coupled to the second communication network through a second NIC. The first computing device is configured to communicate through the first NIC first communication network until it determines that it is not receiving bridge protocol data units (BPDUs) and then to communicate through the second NIC.

According to another aspect of the present invention, a method of operating a control system is disclosed. The method of this embodiment includes monitoring communications at a first computing device received through a first network interface controller; determining that the first computing device is not receiving bridge protocol data units (BPDUs); and switching operation of the first computing device such that it receives communications through a second network interface controller different than the first network interface controller.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of a system according to one embodiment; and

FIG. 2 is a flow chart showing a method according to one embodiment.

The detailed description explains embodiments of the invention, together with advantages and features, by way of example with reference to the drawings.

### DETAILED DESCRIPTION OF THE INVENTION

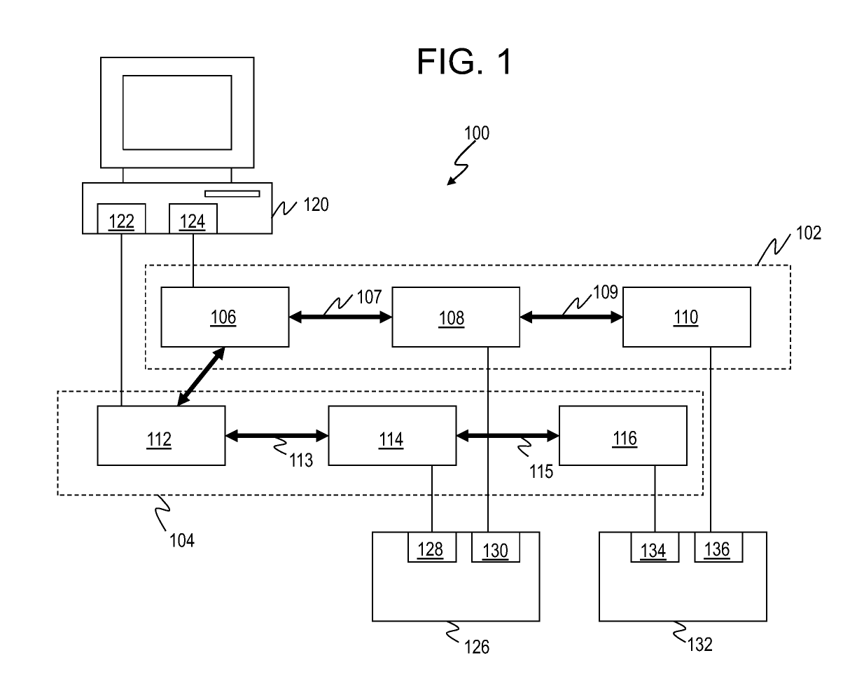

FIG. 1 shows an example of a redundant control system 100 according to one embodiment. The redundant control system 100 (control system) includes at least two communication networks 102 and 104. As shown, each communication network includes three switching devices (switches). Of course the number of switches forming the communication networks 102 and 104 is not limited to three and may include any number equal to or greater than two.

In the example redundant control system 100 shown in FIG. 1, the first communication network 102 includes a first switch 106, a second switch 108 and a third switch 110. The first switch 106 may be coupled to the second switch 108 by a first communication cable 107 and the second switch 108 may be coupled to the third switch 110 by a second communication cable 109.

Similarly, the second communication network 104 includes a fourth switch 112, a fifth switch 114 and a sixth switch 116. The fourth switch 112 may be coupled by a third communications cable 113 to the fifth switch 114 and the fifth switch 114 may be coupled to the sixth switch 116 by a fourth communications cable 115. Of course, in one embodiment, one or more of the communications cables 107, 109, 113 or 115 may be replaced by a wireless communication device.

Each switch may be able to receive data packets from other switches it is directly coupled to, inspect them and pass them on to the next switch. Of course, if the switch is coupled to the desired destination device (e.g., a particular computer), the switch does not pass the information on. Rather, it provides packets to the destination device coupled to it.

In one embodiment, the communication networks 102 and 104 may be Ethernet communication networks. Of course, the communication networks 102 and 104 could be other types of communication networks including, for example, a local area network, a wide area network, an intranet or a wireless communication network.

In one embodiment, the first communication network 102 may be coupled to the second communication network 104 via a crossover cable 118. In one embodiment, the wires in the crossover cable 118 are “crossed” so that output signals from the transmitting device are properly sent as input signals to the receiving end and vice versa. In this manner, all communications on the first communication network 102 may be replicated on the second communication network 104 and vice versa.

The first switch 106 and the fourth switch 112 may be coupled to a first computing device 118. In one embodiment, the first computing device 118 is coupled to the first switch 106 via first network interface controller (NIC) 122. In this embodiment, a second NIC 124 couples the first computing device 118 to the fourth switch 112. A network interface controller (NIC) is a hardware device that handles an interface to a computer network and allows a computing device to access that network. In this manner, the first computing device 118 is coupled to both first communications network 102 and the second communications network 104.

The redundant control system 100 may include any number of computing devices coupled to the first and second networks. As illustrated in FIG. 1, a second computing device 126 and a third computing device 132 are provided. Similar to the first computing device 120, the second computing device 126 and the third computing device 132 may both include at least two NICs. In particular, the second computing device 126 includes a third NIC 128 connected to the first communication network 102 via the second switch 108 and a fourth NIC 130 connected to the second communication network 104 via the fifth switch 114. Similarly, the third computing device 132 includes a fifth NIC 134 connected to the first communication network 102 via the third switch 110 and a sixth NIC 136 connected to the second communication network 104 via the sixth switch 114.

The computing devices 120, 126 and 132 may be any type of computing device. For example, the computing devices may be a computer or computing platform, and may include a terminal, wireless device, information appliance, device, workstation, mini-computer, mainframe computer, personal digital assistant (PDA) or other computing device. It shall be understood that the computing devices may include multiple computing devices linked together by a communication network. For example, there may exist a client-server relationship between two devices and processing may be split between the two. In one embodiment, the first computing device 120 may provide a human-machine interface (HMI) to a control system for operating a process. In one embodiment, the second computing device 126 is connected to a turbine and the third computing device 132 is connected to an exciter.

In one operation, the first computing device 120 communicates over only one of the NICs 122 and 124. That is, the first computing device 120 is limited to communicating only over one NIC. The first computing device 120 may make a random decision as to which NIC to communicate over. The first computing device 120 does not typically change the NIC being utilized.

In one embodiment, one of the switches may be designated as the spanning tree root bridge under the spanning tree protocol. The spanning tree protocol allows a network design to include spare (redundant) links to provide automatic backup paths if an active link fails, without the danger of bridge loops, or the need for manual enabling/disabling of these backup links. Switches that may operate the spanning tree protocol include algorithms for electing one of the servers as the root bridge. The root bridge server periodically broadcasts spanning tree protocol packets. The packets are typically referred to as BPDUs (bridge protocol data units).

According to one embodiment, in the event that the first computing device 120 determines that it is not receiving the BPDUs, it switches the NIC it is communicating through. For example, in the embodiment illustrated in FIG. 1, if the first computing device 120 is communicating through the first NIC 122 and the fourth switch 112 fails, there is no way it can receive the BPDUs. Accordingly, the first computing device 120 will switch to an operating mode where it communicates through the second NIC 122. In one embodiment, the second computing device 126 and third computing device 132 may communicate though one or more NICs simultaneously. Of course, in the event that the first computing device 120 includes more than two NICs, the computing device may select NICs until it begins to receive BPDUs.

It shall be understood that while the terms “first,” “second” and the like have been used to distinctly identify certain devices in the system 100, in the appended claims, the ordering and naming of certain devices may vary depending on the context.

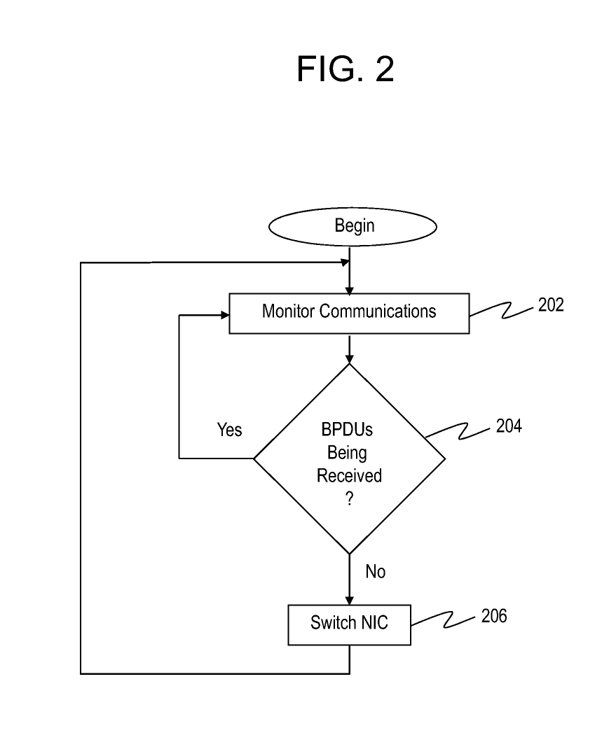

FIG. 2 is a block diagram showing a method according to one embodiment of the present invention. The method shown assumes that the first computing device 120 (FIG. 1) is currently communicating to at least one other computing device through a redundant communication system. At block 202, the first computing device, which is communicating through one of its NICs, is monitoring the communications it receives. At block 204, the first computing device determines if BPDUs are being received. This may include monitoring communications for several predetermined time periods in which a BPDU would be expected. If one or more BPDUs are received, processing returns to block 202. Otherwise, at block 206 the first computing device switches from the NIC it is currently communicating on to another of the NICs it contains. Processing then returns to block 202.

In support of the teachings herein, various analysis components may be used, including digital and/or an analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement methods of the present invention. These instructions may provide for equipment operation, control, data collection and analysis and other functions deemed relevant by a system designer, owner, user or other such personnel, in addition to the functions described in this disclosure. Accordingly, the present invention may include switching the operation of a computing device in a redundant computing system such that it communicates on a different NIC when it is determined that the computing device is not receiving BPDUs.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system including redundant communication paths, the system comprising:
a first communication network including a first switch and a second switch connected to the first switch;
a second communication network including a third switch and fourth switch coupled to the third switch;
a first computing device coupled to the first communications network through a first network interface controller (NIC) and coupled to the second communication network through a second NIC, the first computing device configured to communicate through the first NIC first communication network until it determines the absence of receiving bridge protocol data units (BPDUs) and then to communicate through the second NIC.

2. The system of claim 1, wherein the first and second communication networks are Ethernet networks.

3. The system of claim 1, wherein the first, second, third and fourth switches are Ethernet switches and support a spanning tree protocol.

4. The system of claim 1, further comprising:
a second computing device coupled the first and second communication networks.

5. The system of claim 4, wherein the second computing device is a device controller.

6. The system of claim 5, wherein the second computing device is configured to control operation of a turbine.

7. The system of claim 1, wherein the first computing device is configured to provide a human-machine interface.

8. The system of claim 1, wherein the first network is coupled to the second network.

9. The system of claim 1, further comprising a crossover cable that couples the first network to the second network.

10. A method of operating a control system, the method comprising:
monitoring communications at a first computing device received through a first network interface controller;
determining that the first computing device is not receiving bridge protocol data units (BPDUs); and
switching operation of the first computing device such that it receives communications through a second network interface controller different than the first network interface controller.

11. The method of claim 10, further comprising:
forming a first communications network that includes two or more switches;
forming a second communication network that includes two or more switches; and
coupling the first network interface controller to the first communication network; and
coupling the second network interface controller to the second communications network.

12. The method of claim 11, further comprising:
coupling the first communication network to a second computing device; and
coupling the second communication network to the second computing device.

13. The method if claim 12, wherein the second computing device is a device controller.

14. The method of claim 11, further comprising:
coupling the first communication network to the second communication with a cable.
